(19) United States
(12) Patent Application Publication
(10) Pub. No.: US 2015/0347555 A1
(43) Pub. Date: Dec. 3, 2015

(54) WATERWHEEL SHARDING

(71) Applicant: LinkedIn Corporation, Mountain View, CA (US)

(72) Inventors: Nishant Vyas, Mountain View, CA (US); Nathan C. Woodhams, Milpitas, CA (US); James Chen, Oakland, CA (US)

(21) Appl. No.: 14/338,211

(22) Filed: Jul. 22, 2014

Related U.S. Application Data
(60) Provisional application No. 62/006,129, filed on May 31, 2014.

(51) Int. Cl. G06F 17/30

(52) U.S. Cl. CPC G06F 17/30584; G06F 17/30073; G06F 17/30876

(57) ABSTRACT

Techniques for partitioning a database are described. Consistent with some embodiments, a technique may include maintaining a plurality of database instances, the plurality of database instances having a first partition and a second partition. Additionally, the method may include assigning first invitations to the first partition and existing invitations to the second partition. The first invitations can be created after a first date. The existing invitations can be created before the first date and after a second date, and where the second date occurred before the first date. Furthermore, the method may include archiving old invitations, the old invitations being created before the second date. Subsequently, the method may include receiving an invitation request and requesting invitation information associated with the invitation request, the invitation request having at least one of an invitee identifier, an inviter identifier, and a unique identifier.

### PRIORITY APPLICATION

This application claims priority to Provisional U.S. Patent Application Ser. No. 62/006,129, filed May 31, 2014, and which is incorporated herein by reference in its entirety.

### TECHNICAL FIELD

The subject matter disclosed herein generally relates to the partitioning of a database. Specifically, the present disclosure generally relates to techniques for partitioning a database into a plurality of database shards.

### BACKGROUND

A database shard can be a partition in a database or a search engine. Each individual partition can be referred to as a shard. For example, horizontal partitioning can be a database design principle whereby rows of a database table are held separately. Each partition forms part of a shard, which may in turn be located on a separate database server or physical location.

By partitioning a database into a plurality of shards, the database tables can be divided and distributed into multiple servers. As a result, the total number of rows in each table in each database is reduced. Additionally, a reduction in the number of rows in each table in each database can reduce the index size, which can improve search performance.

Furthermore, a database shard can be placed on separate hardware, and multiple shards can be placed on multiple machines. This enables a distribution of the database over a large number of machines, which means that the database performance can be spread out over multiple machines, greatly improving performance.

In addition, if the database shard is sharded and queried using just one known variable associated with all of the data (e.g., membership identification), then it may be possible to infer the appropriate shard membership. As a result, the database can be automatically sharded based on the known variable.

However, in some implementations, some databases can be queried on a plurality of variables associated with the data, and not just one known variable. In current implementations when the database cannot be sharded based on one known variable, a manual partition by hand-coding may be needed for sharding the database.

### BRIEF DESCRIPTION OF THE DRAWINGS

Some embodiments are illustrated by way of example and not limitation in the figures of the accompanying drawings.

FIG. 1 is a network diagram illustrating a network environment suitable for a social network, according to some example embodiments.

FIG. 2 a block diagram illustrating various modules of a social network service, according to some embodiments.

FIG. 3 illustrates the high-level architecture of an invitation archival system, according to some embodiments.

FIG. 4 is a flowchart illustrating a method for an invitation archival flow for FIG. 3, according to some embodiments.

FIG. 5 illustrates the initial stage of waterwheel sharding, according to some embodiments of the present invention.

FIG. 6 illustrates a rotational stage of waterwheel sharding, according to some embodiments of the present invention.

FIG. 7 illustrates a steady stage of waterwheel sharding, according to some embodiments of the present invention.

FIG. 8 is a flowchart illustrating the waterwheel sharding method described in FIGS. 5-7, according to some embodiments.

FIG. 9 is a block diagram illustrating components of a machine, according to some example embodiments, able to read instructions from a machine-readable medium and perform any one or more of the methodologies discussed herein.

### DETAILED DESCRIPTION

Example methods and systems are directed to techniques for automatically partitioning a database. More specifically, the present disclosure relates to methods, systems and computer program products for sharding techniques when a database cannot be sharded based on one known variable.

Databases, such as an invitation database for a social network, may be partitioned into a plurality of shards when the index table reaches the physical limits of the hardware.

For example, in a social network, when a member requests an invitation from another member to connect, the invitation can be stored in an invitation database.

In conventional implementations, the invitation service may communicate with one single (e.g., unsharded) database instance. A database (e.g., invitation store) may manage all invitations for the social network. As a result, a single index table is continuously growing, which may reach hardware limits. Therefore, as the social network grows, the data size of the index table associated with each invitation may reach the storage limits of the database.

However, in some instances, the database schema and sheer size of the data may reach the limits of the physical hardware installation. Although the size in bytes of an invitation is small and physical storage can be added ad infinitum given sufficient funds, the memory and CPU capacity can be limiting due to the indexes of the data to be maintained.

In conventional implementations, when the size of a database gets too large, the database is sharded. For example, in a social network system, another instance of the database is added, and the database query can be based on a specific key (e.g., Member ID).

However, invitation services may need to be sharded on three separate keys. The three separate keys can be an inviter identifier (ID), invitee ID and invitation ID. The inviter ID can be the member ID of the requestor. The invitee ID can be the member ID or the email address of the requested. The invitation ID can be a global unique invitation identifier.

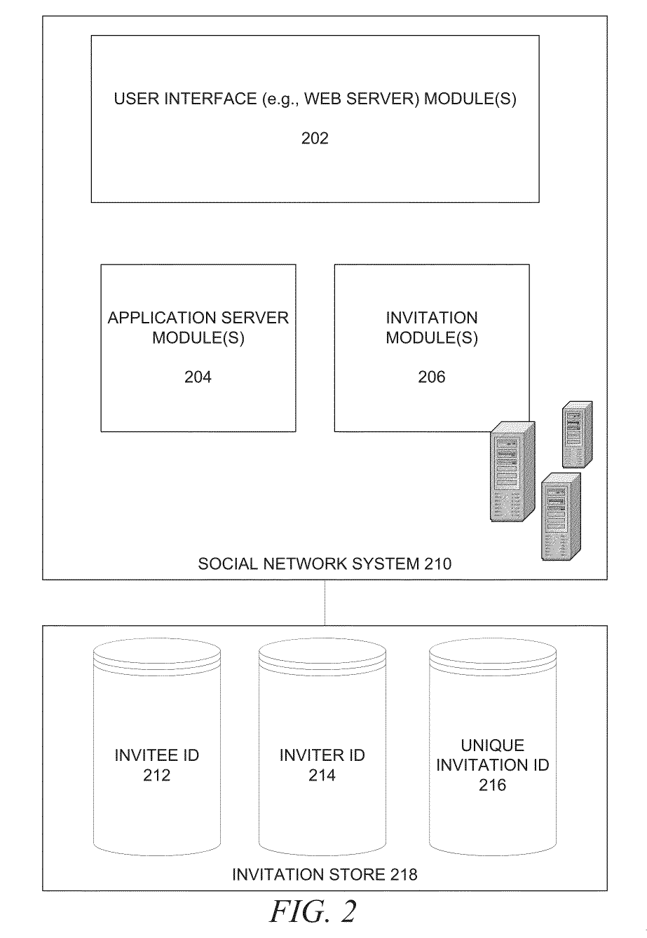

For example, an invitation email can be sent to the invitee's email address. Therefore, when the invitee accepts the invitation, the only information received by the invitation module(s) 206 (as shown in FIG. 2) can be the invitee's email address or the unique invitation ID. To protect the privacy of members, the inviter ID, which can be the member ID of the inviter, may not be sent with the invitation email.

Given that the database can be queried using three separate keys, conventional methods of sharding the database may not work properly. Multiple mapping tables in memory may be needed when sharding using conventional methods. Additionally, sharding when using conventional methods may not be implemented quickly.

In some embodiments, the invitation database cannot be partitioned based on a single known variable. In some instances, each invitation can include three different identifications depending on where the invitation is coming from. The different identifications can be due to security and privacy concerns in order to protect member data. To illustrate, each invitation can be associated with a member requesting the connection (i.e., invitee identifier (ID)), a member being requested to connect (i.e., inviter ID), and a unique invitation ID.

As previously mentioned, because of security and privacy concerns, the invitations may not always be queried based on a specific known variable (e.g., invitee ID, inviter ID, unique invitation ID). For example, when a first user wants to view all pending invitation request, the database is queried based on the first user's member ID as the inviter ID. Alternatively, when a second user wants to view all the pending invitations that the second user has sent out, the database is queried based on the second user's member ID as the invitee ID. Therefore, in some instances, current implementations of the invitation database may not be automatically partitioned since the social network may be able to easily query the invitation database.

To further illustrate, depending on the type of invitation, the invitation may be queried based on only one variable (e.g., an invitee ID, inviter ID, a unique invitation ID). As previously mentioned, when a first user wants to view all pending invitation requests, the social network may only query the invitation database with an inviter ID. Additionally, the first user can be a part of the social network (e.g., query database using first user's member ID), or a user outside the social network (e.g., query database using email address associated with the first user). Alternatively, when a second user wants to view all invitations sent out by the second user, the social network may only query the invitation database with an invitee ID (e.g., query database using second user's member ID). As illustrated by this example, given that the database query may have different non-overlapping information, the invitation database cannot easily be partitioned just based on one known variable.

### Manual Archiving

In current implementations, manual archiving can occur when the invitation database reaches memory and CPU capacity limits due to the indexes of the data. For example, given a set time period, all invitations older than the start date can be removed from the database and copied to an archive. This can be a manual operation performed by a database administrator. Manual archiving can be incredibly complex, and there may be a risk for error in the archiving process. Additionally, there may be downtime to the social network. Furthermore, in some instances, the old pending invitations that are archived may not function. For example, when a user accepts a pending invitation after a long period of time, the invitation may have been archived, which may not result in the invitation being updated in the database and a relationship link being formed between the invitee and inviter.

### System for an Automatic Aggressive Archiving

Embodiments of the present invention can provide an automatic management of the invitations' data size. The physical size can be controlled by the service that is responsible for sweeping old or expired data from the store by archiving the data.

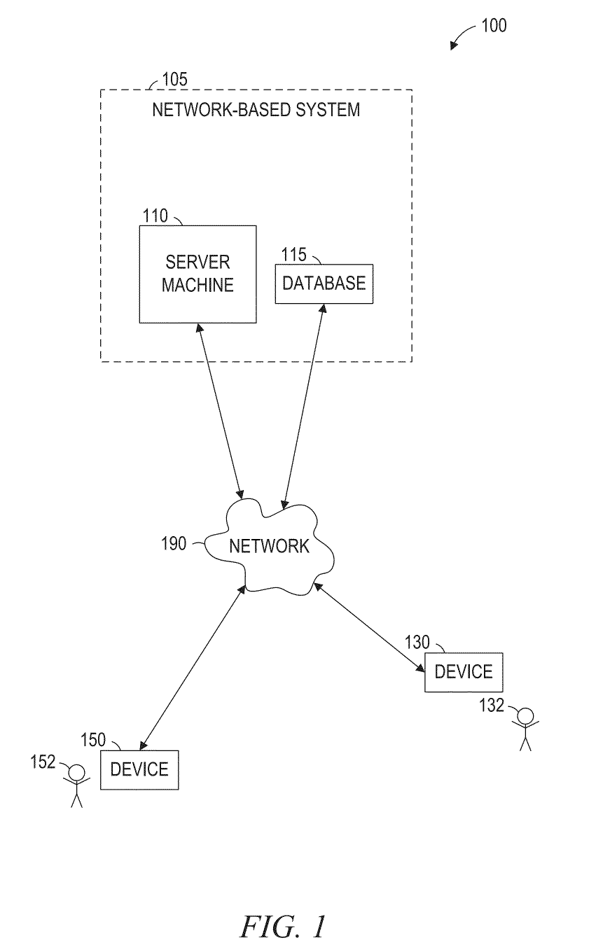

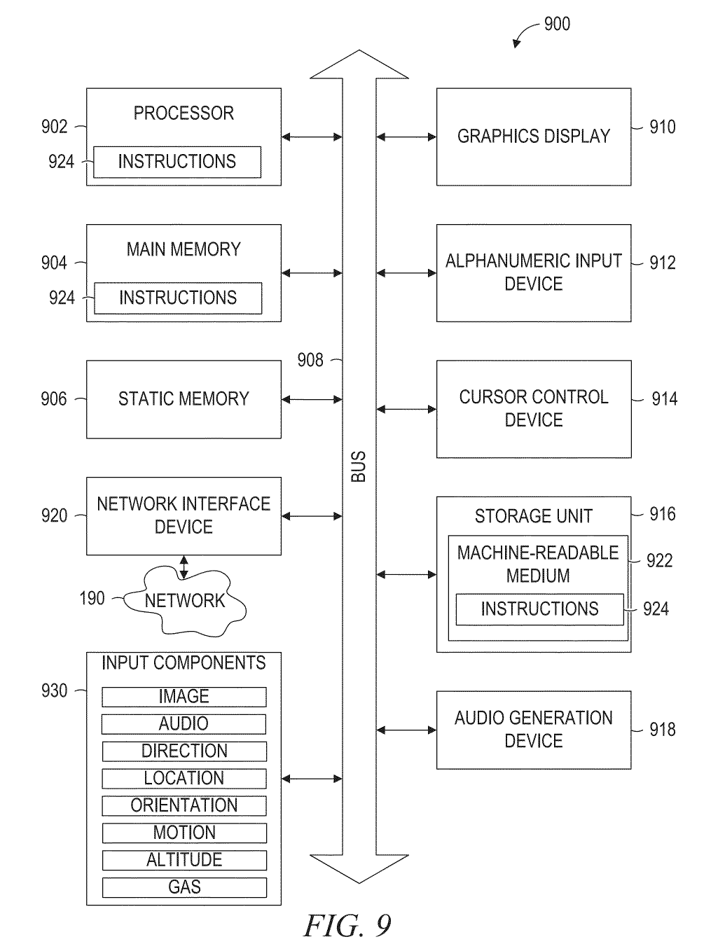

FIG. 1 is a network diagram illustrating a network environment 100 suitable for a social network service, according to some example embodiments. The network environment 100 includes a server machine 110, a database 115, a first device 130 for a first user 132, and a second device 150 for a second user 152, all communicatively coupled to each other via a network 190. The server machine 110 may form all or part of a network-based system 105 (e.g., a cloud-based server system configured to provide one or more services to the devices 130 and 150). The database 115 can be an invitation store 218, as illustrated in FIG. 2. As further described herein, techniques for sharding the database 115 can be implemented. The server machine 110, the first device 130 and the second device 150 may each be implemented in a computer system, in whole or in part, as described below with respect to FIG. 9.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152. In some instances, user 132 can send an invitation to user 152 to connect in a social network (e.g., network-based system 105).

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, an invitation store 218, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

FIG. 2 is a block diagram illustrating components of a social network system 210 according to some example embodiments. The social network system 210 is an example of a network-based system 105 of FIG. 1. The social network system 210 can include a user interface 202, application server module(s) 204, and invitation module(s) 206, all configured to communicate with each other (e.g., via a bus, shared memory, a switch). Furthermore, the social network system 210 can communicate with database 115 of FIG. 1, such as an invitation store 218. The invitation store 218 can include invitations with an invitee ID 212, an inviter ID 214, and a unique invitation ID 216.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In FIG. 2, the front end consists of a user interface module (e.g., a web server) 202, which receives requests (e.g., invitation requests) via network 190 from various client-computing devices (e.g., devices 130 and 150), and communicates appropriate responses to the requesting client devices. For example, the user interface module(s) 202 may receive invitation requests in the form of Hypertext Transport Protocol (HTTP) requests, or other web-based, application programming interface (API) requests. The application logic layer includes various application server module(s) 204, which, in conjunction with the user interface module(s) 202, generates various user interfaces (e.g., web pages) with data retrieved from various data sources (e.g., invitation store 218) in the data layer. With some embodiments, individual application server modules 204 are used to implement the functionality associated with various services and features of the social network system 210.

The invitation module 206, in conjunction with the user interface module(s) 202 and the application server module(s) 204, can present pending invitations to a member based on an invitation query. Depending on the type of the request, the pending invitations can be queried based on an invitee ID 212, an inviter ID 214 or a unique invitation ID 216.

As previously mentioned, the invitation query may not have all three identifiers (e.g., invitee ID 212, inviter ID 214, a unique invitation ID 216). Therefore, in some instances, the invitation database query may have to be versatile to return invitation information based on any one of the three identifiers.

For example, depending on the type of invitation, the invitation may be queried based on only one variable (e.g., an invitee ID 212, inviter ID 214, a unique invitation ID 216). When a first member wants to view all pending invitation requests, the social network system 210 may only query the invitation store 218 with an inviter ID 214. Alternatively, when a second member wants to view all invitations sent out by the second member, the social network system 210 may only query the invitation store 218 with an invitee ID 212.

Social network services can provide their users with a mechanism for defining their relationships (e.g., 1^{st} degree connection, 2^{nd} degree connection) with other people. This digital representation of real-world relationships is frequently referred to as social graph data. The connection of the nodes can be based on invitations to connect between different entities.

In some instances, the social graph data can be maintained by a third-party social network service. For example, users can indicate a relationship or association with a variety of real-world entities and/or objects. Typically, a user input is captured when a user interacts with a particular graphical user interface element, such as a button, which is generally presented in connection with the particular entity or object and frequently labelled in some meaningful way (e.g., “like,” “+1.” “follow”).

Once registered, a member may invite other members, or be invited by other members, to connect via the social network service. A “connection” may call for a bi-lateral agreement by the members, such that both members acknowledge the establishment of the connection. According to some embodiments, the bi-lateral agreement by the members can be based on invitations to connect.

Similarly, with some embodiments, a member may elect to “follow” another member. In contrast to establishing a connection, the concept of “following” another member typically is a unilateral operation, and at least with some embodiments, does not require acknowledgement or approval by the member being followed. When one member follows another, the member who is following may receive status updates or other messages published by the member being followed, or relating to various activities undertaken by the member being followed. In some instances, invitations can be used for users to follow other members. Additionally, invitation store 218 can store data associated with members following other members.

In any case, the various invitations' request for an association and/or relationship between a first member and a second member, or with other entities and objects, are stored and maintained within the invitation store 218.

### Invitation Archiving System

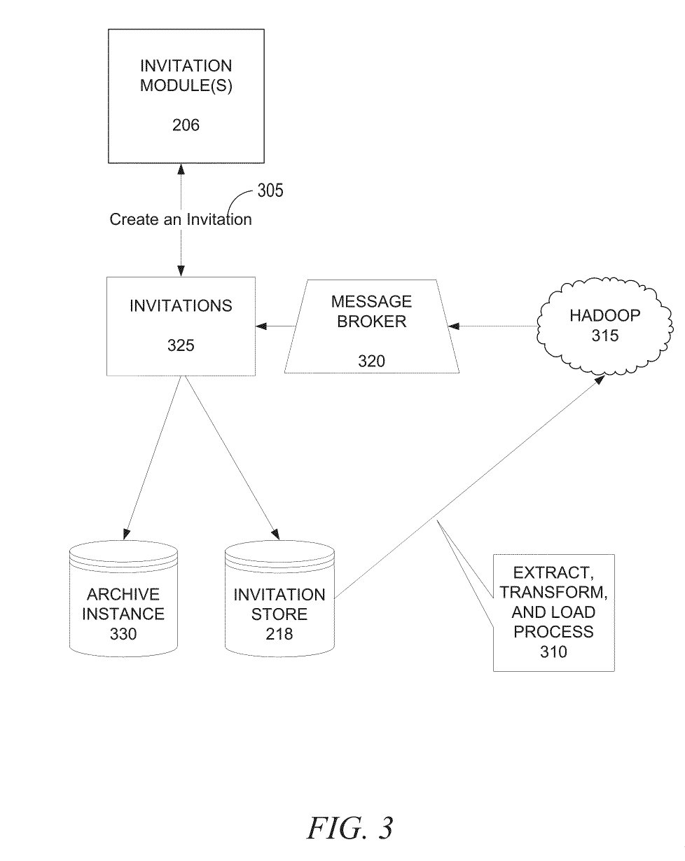

FIG. 3 illustrates a high-level architecture of an invitation archival system, according to some embodiments. In some instances, the invitation archival system can use an automatic aggressive archiving technique. As illustrated in FIG. 3, embodiments of the present invention can provide an automatic management of the invitations' data size by archiving old invitations from the invitation store 218. For example, the physical size of the invitation index can be controlled by invitation module(s) 206. The invitation module(s) 206 can archive invitations from the invitation store 218 that are created before a certain date. Alternatively, invitation module(s) 206 can delete invitations from invitation store 218, when the invitations were created before a certain date.

As illustrated in FIG. 3, invitation module(s) 206 can create an invitation at 305. The invitation can be one of the invitations 325 that are stored (e.g., written) in the invitation store 218. The invitation can be copied to Hadoop 315 using the extract, transform, and load process 310.

Additionally, an offline job can be executed in Hadoop 315 to identify invitations records which should either be archived or deleted. The identification can be based on the date that the invitation was created. For example, all invitations that are older than one year can automatically be archived.

Furthermore, the offline job can transmit messages associated with the invitations 325 via message broker 320 (e.g., Kafka events). The messages are received by the invitation module(s) 206. Subsequently, the invitation module(s) 206 can copy the invitation from the invitations 325 specified by the message broker 320 to an archive instance 330 and remove the invitation from the invitation store 218.

### Method for an Automatic Aggressive Archiving

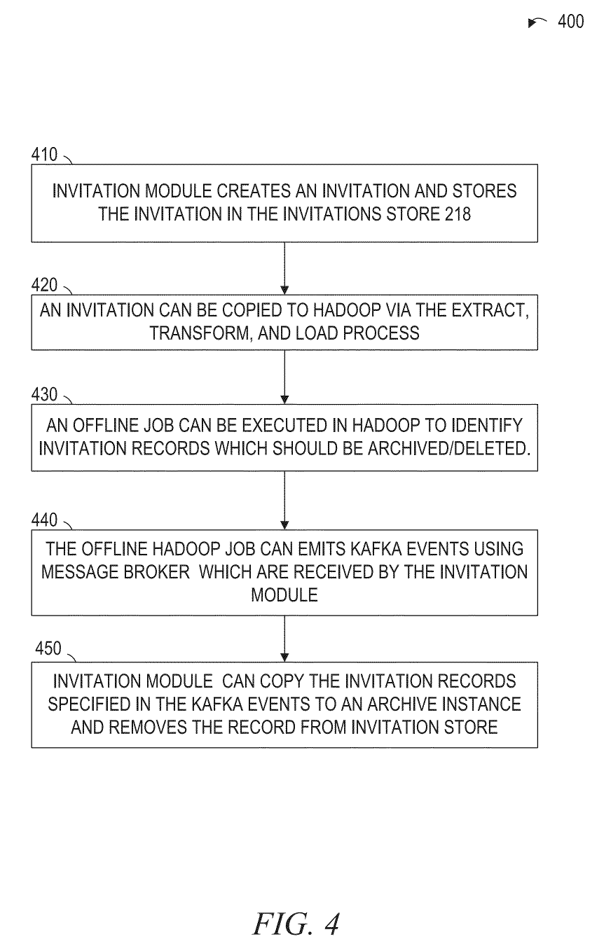

FIG. 4 is a flowchart illustrating a method 400 for an invitation archival flow for FIG. 3, according to some embodiments.

At operation 410, invitation module(s) 206 can create an invitation. The invitation can be written to the invitation store 218. For example, an invitation can be created when a first member requests a second member to connect in a social network. Based on the request, invitation module(s) 206 can create the invitation with an invitee ID 212, an inviter ID 214 and a unique invitation ID 216. The invitation can be queried from the invitation store 218 using either one of these identifiers.

At operation 420, the invitation can be copied to Hadoop 315 via the extract, transform, and load process 310. Operation 420 can be similar to process 310 in FIG. 3.

At operation 430, an offline job can be executed in Hadoop 315 to identify invitation records which should be archived and/or deleted.

At operation 440, the offline Hadoop job can emit Kafka events using message broker 320 which are received by the invitation module(s) 206 (or its delegate).

At operation 450, the invitation module(s) 206 can copy the invitation records specified in the Kafka events in operations 440 to an archive instance 330 and remove the record from invitation store 218.

Method 400 may have the benefit of not requiring manual intervention to archive invitations (i.e., manual partition by hand-coding). For example, once the invitations are created, the archival process may be completely automated. Additionally, if the service has any issues in managing the invitations requested by the Hadoop job, the missed invitations can be caught in the next execution.

However, method 400 may not be viable given a large (e.g., millions, billions) number of invitations which have to be managed to keep up with the number of invitations created. Under method 400, new invitations can create an additional load which can reduce the retrieval speed of information in the database. Additionally, method 400 can have a continuously growing archived data set which may eventually reach the maximum capacity of the storage medium.

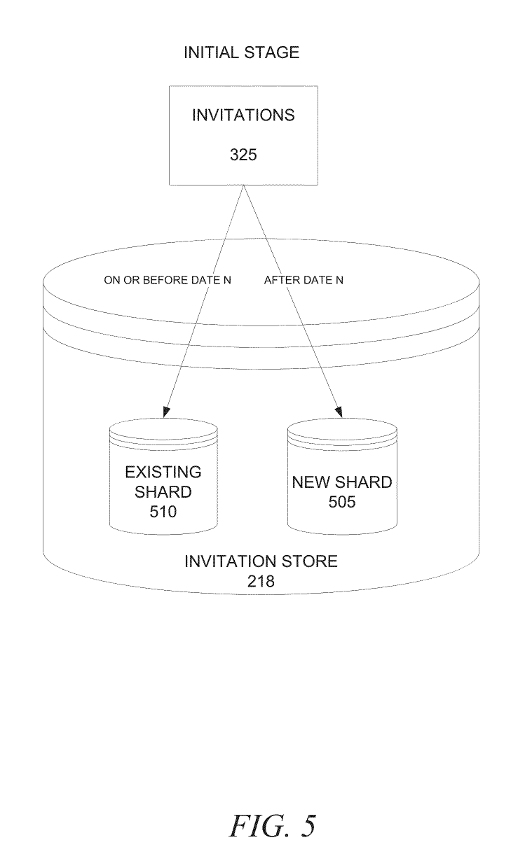

Therefore, techniques for waterwheel sharding are described herein (e.g., FIGS. 5-8) to overcome the shortfalls of current implementations for archiving invitations.

### Waterwheel Sharding

FIG. 5 illustrates the initial stage of waterwheel sharding, according to some embodiments of the present invention. Waterwheel sharding can use the limited lifetime of an invitation as a mechanism for routing to a shard. Waterwheel sharding can be characterized by a continuously moving window of shards which represent invitations for a specific amount of time (e.g., 6 months, years) of invitations, with older shards being archived into an offline archive.

In some instances, the initial stage can be to modify the code to support multiple database (DB) instances. In this scenario, both instances can be read/written but only one will be the recipient of new invitation records. The existing shard 510 can contain a collection of existing invitations which have creation times on or before date N. The new shard 505 can store invitations 325 with creation dates starting immediately after date N. All new invitations 325 can be written to the new shard 505. Additionally, invitations 325 in both shards 510 and 505 can be updated when the record changes (e.g., invitation accepted, invitation rejected, invitation request is removed).

Given that new invitations 325 are stored in the new shard 505, the new shard 505 can be set up with read, update and create functions. The existing shard 510 can be set up with read and update functions. During a query to the invitation store 218 for invitation information, invitation module(s) 206 can submit two read queries to both the new shard 505 and the existing shard 510.

Unlike conventional sharding methods, where a specific shard is queried based on a specific key, in the waterwheel sharding method, both new shards are queried. In some instances, the time stamp may not necessarily let the invitation module(s) 206 determine which shard to query. As a result, there may not be sharding logic to determine which shard to query. Therefore, invitation module(s) 206 can treat both shards (i.e., new shard 505, existing shard 510) as readable storage.

Alternatively, invitation module(s) 206 can determine which shard to query based on determined information. For example, if the invitation module(s) 206 can determine that the invitation was created before date N, then invitation module(s) 206 can query existing shard 510.

Once the requested information is received, the invitation module(s) 206 can update the shard that transmitted the requested information. For example, if the requested invitation information is stored in new shard 505, then the requested invitation information is transmitted by the new shard 505. Subsequently, if the invitation information was requested by the invitee so that the invitee can accept the invitation, then the invitation module(s) 206 can update the invitation information in the new shard 505 to indicate that the invitation has been accepted.

The state of the invitation can be updated when the invitation is accepted, rejected, withdrawn, or explicitly ignored. The invitation can be accepted or rejected by the invitee. Additionally, the invitation can be withdrawn by the inviter before it has been accepted or rejected by the invitee. Furthermore, the invitation can be explicitly ignored by the invitee.

It should be noted that one implementation of this scenario relies upon a scatter, gather and read strategy. In the scatter, gather and read strategy, both existing shard 510 and new shard 505 can be queried when an invitation is requested. For example, when invitations 325 information is requested, invitation module(s) 206 can query both the new shard 505 and the existing shard 510.

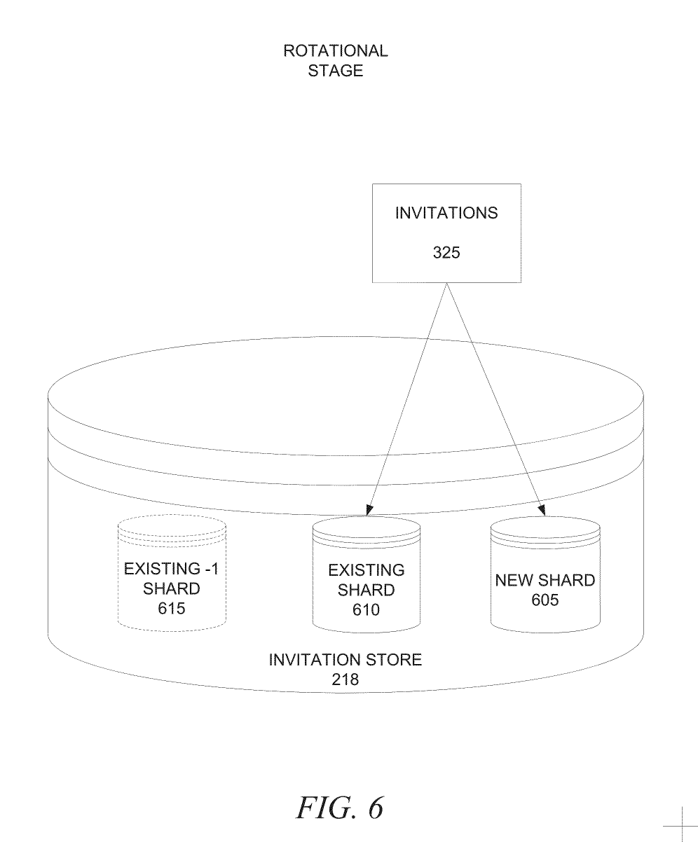

FIG. 6 illustrates a rotational stage of waterwheel sharding, according to some embodiments of the present invention. A rotational stage can occur after a specific amount of time (e.g., 6 months, 1 year, 2 years) has passed.

Once a specified time window has passed (e.g., 6 months, 1 year, 2 years), the waterwheel sharding process can proceed as it did in the initial stage. A new database instance, such as new shard 605, can be added to the invitation store 218. Additionally, the previous new shard 505 from FIG. 5 can become existing shard 610 in FIG. 6. Furthermore, the previous existing shard 510 from FIG. 5 can become existing-1 shard 615 in FIG. 6.

For example, in a 6-month increment implementation, new shard 605 can be added to the invitation store 218, and the new shard 605 can store all new invitations 325. The existing shard 610 can store all the previously created invitations 325 from the past six months. Additionally, all invitations 325 that are older than six months can be stored in the existing-1 shard 615.

In some instances, the existing-1 shard 615 can be archived and removed from online access (e.g., invitation store 218). The existing-1 shard 615 can then be archived manually without fear of impacting any production system. For example, based on empirical data, when an invitation has been created before date N (e.g., 6 months, 1 year, 2 years), the likelihood that the invitation is accepted is very minimal. In some instances, if an invitation is archived and the invitee wants to connect to the inviter, then the invitee can send an invitation request to the inviter.

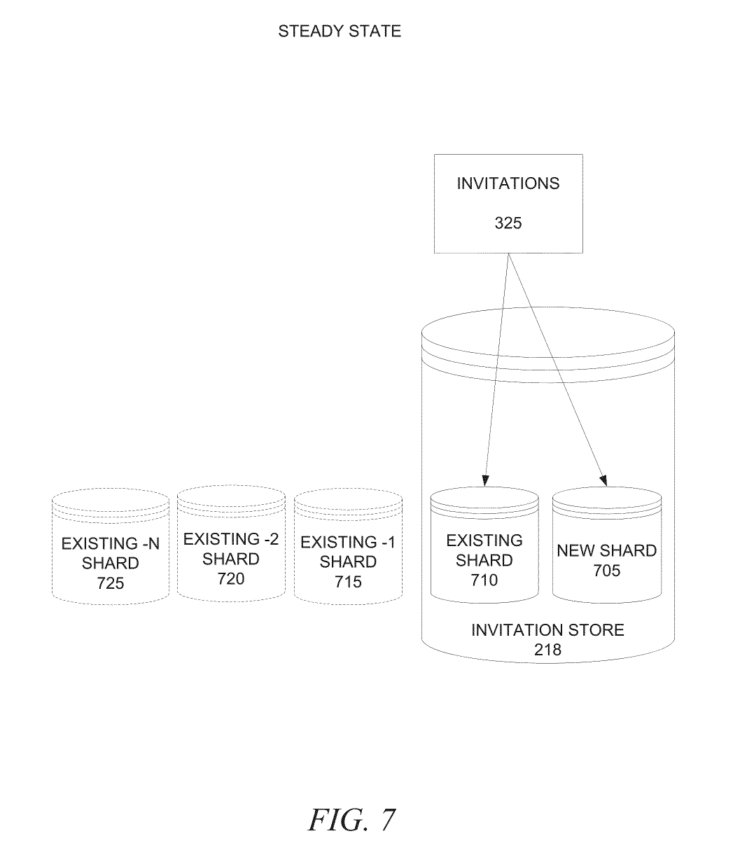

FIG. 7 illustrates a steady stage of waterwheel sharding, according to some embodiments of the present invention.

In some instances, as time progresses, the invitation service in the social network system 210 continues to add new storage instances (e.g., new shard 705) and archiving older storage instances (e.g., existing-1 shard 715, existing-2 shard 720, existing-n shard 725).

For example, when new shard 705 is added, the previous new shard 605 from FIG. 6 can become existing shard 710. All newly created invitations 325 can be stored in new shard 705. Additionally, existing shard 610 from FIG. 6 can be archived into existing-1 shard 715. Furthermore, existing-1 shard 615 in FIG. 6 now becomes existing-2 shard 720, and so on.

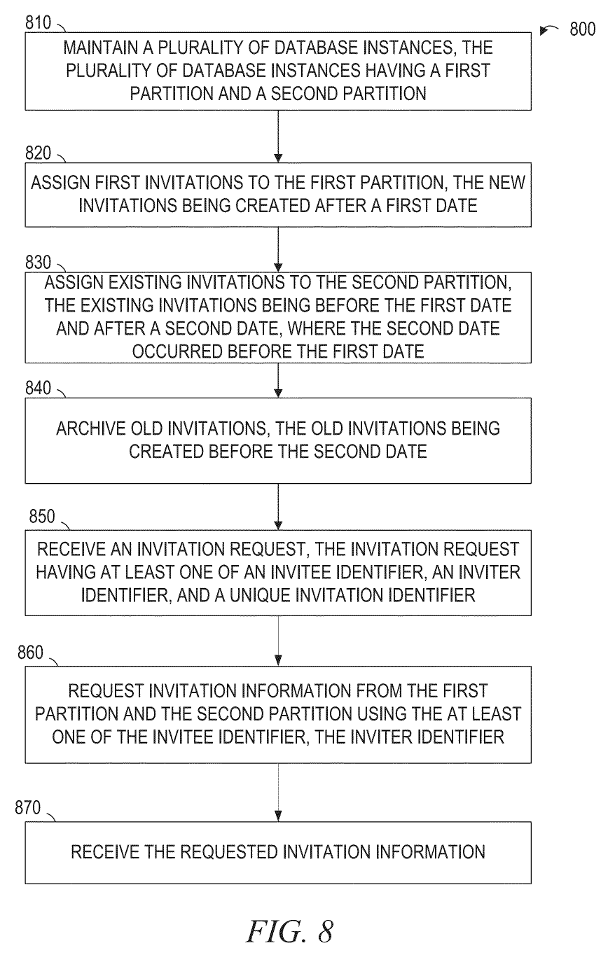

FIG. 8 is a flowchart illustrating the waterwheel sharding method described in FIGS. 5-7, according to some embodiments.

At operation 810, invitation module(s) 206 can maintain a plurality of database instances. The invitation store 218 can be an example of the plurality of database instances. Additionally, the plurality of database instances can have a first partition and a second partition. The new shard 705, new shard 605, and new shard 505 can be examples of the first partition. The existing shard 710, existing shard 610 and existing shard 510 can be examples of the second partition.

At operation 820, invitation module(s) 206 can assign first (e.g., created after a first date, newly created) invitations to the first partition. The first invitations can be newly created and/or created after a first date. For example, invitation module(s) 206 can assign all invitations 325 that have been created after a first date (e.g., Jul. 1, 2014) to the first partition. Additionally, at some time in the future (e.g., 6-months, 1 year, 2 years), when another new shard is created, the newly created invitation can be store in the new shard.

At operation 830, invitation module(s) 206 can assign existing invitations 325 to the second partition. The existing invitations can be created before the first date (e.g., Jul. 1, 2014) and after a second date (e.g., Jan. 1, 2014), where the second date occurred before the first date.

At operation 840, invitation module(s) 206 can archive old invitations. The old invitations can be created before the second date (e.g., Jan. 1, 2014). To illustrate operations 820-840, in the previously described 6-month increment implementation, newly created invitations and all invitations created after Jul. 1, 2014 are assigned (e.g., stored) to the first partition. Additionally, existing invitation that are created before Jul. 1, 2014 are assigned to the second partition, and invitations that were created before Jan. 1, 2014 are archived.

Subsequently, when invitation module(s) 206 receives an invitation request at operation 850, the invitation module(s) 206 can request information from the first partition and the second partition at operation 860. The invitation request can contain at least one of invitee ID 212, inviter ID 214 and unique invitation ID 216. In some instances, the invitation request may only contain one of the IDs 212-216. Therefore, the invitation store 218 and the invitation module(s) 206 are designed to be versatile enough to query invitation information based on any one of the invitee ID 212, inviter ID 214 and a unique invitation ID 216.

At operation 870, once the invitation information is received (e.g., queried) in operation 860, invitation module(s) 206 can receive the requested invitation information. The received information can be used to update the connections between members in the social network system 210.

Optionally, concurrent to, or after, transmitting the invitation information, invitation module(s) 206 can update the invitation store 218. For example, if a member has accepted an invitation to connect, the invitation store 218 can be updated with this new information (e.g., invitation request can be updated as being accepted).

One of the benefits of this approach is that it does not require manual partitioning by hand-coding. The time-based shards which are gradually retired allow for flexibility in implementation elegance. For example, the implementation can take a phased approach without each phase increasing the sophistication of the database.

Additionally, a data router technique can be used with automation applied to where data is read and written. For example, the database can know which one of the shards, based on the creation date of the invitation, to query to retrieve the invitation information.

Furthermore, waterwheel sharding may not require periodic maintenance by a database administration team as new shards are added and old shards are archived. Moreover, waterwheel sharding, in some instances, may need the attention of service developers to increment the shard locations via service configuration.

According to various example embodiments, one or more of the methodologies described herein may facilitate portioning a database. Moreover, one or more of the methodologies described herein may facilitate querying a portioned database with one of a plurality of known variables.

When these effects are considered in aggregate, one or more of the methodologies described herein may obviate a need for certain efforts or resources that otherwise would be involved in partitioning a database. Computing resources used by one or more machines, databases, or devices (e.g., within the network environment 100) may similarly be reduced. Examples of such computing resources include processor cycles, network traffic, memory usage, data storage capacity, power consumption, and cooling capacity.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

FIG. 9 is a block diagram illustrating components of a machine 900, according to some example embodiments, able to read instructions 924 from a machine-readable medium 922 (e.g., a non-transitory machine-readable medium, a machine-readable storage medium, a computer-readable storage medium, or any suitable combination thereof) and perform any one or more of the methodologies discussed herein, in whole or in part. Specifically, FIG. 9 shows the machine 900 in the example form of a computer system (e.g., a computer) within which the instructions 924 (e.g., software, a program, an application, an applet, an app, or other executable code) for causing the machine 900 to perform any one or more of the methodologies discussed herein may be executed, in whole or in part.

In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a distributed (e.g., peer-to-peer) network environment. The machine 900 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include any collection of machines that individually or jointly execute the instructions 924 to perform all or part of any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, an audio generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered machine-readable media (e.g., tangible and non-transitory machine-readable media). The instructions 924 may be transmitted or received over the network 190 via the network interface device 920. For example, the network interface device 920 may communicate the instructions 924 using any one or more transfer protocols (e.g., HTTP).

In some example embodiments, the machine 900 may be a portable computing device, such as a smart phone or tablet computer, and have one or more additional input components 930 (e.g., sensors or gauges). Examples of such input components 930 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 930 may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions 924. The term “machine-readable medium” shall also be taken to include any medium, or combination of multiple media, that is capable of storing the instructions 924 for execution by the machine 900, such that the instructions 924, when executed by one or more processors of the machine 900 (e.g., processor 902), cause the machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
maintaining a plurality of database instances, the plurality of database instances having a first partition and a second partition;
assigning, using an invitation module, first invitations to the first partition, the first invitations being created after a first date;
assigning existing invitations to the second partition, the existing invitations being created before the first date and after a second date, and wherein the second date occurred before the first date;
archiving old invitations, the old invitations being created before the second date;
receiving, using a network interface device, an invitation request, the invitation request having at least one of an invitee identifier, an inviter identifier, and a unique identifier;
requesting invitation information associated with the invitation request from the first partition and the second partition using at least one of the invitee identifier, the inviter identifier, and the unique identifier; and
receiving the requested invitation information.

2. The method of claim 1, further comprising:
creating a new partition in the plurality of database instances after a threshold amount of time has elapsed since the first date;
archiving the existing invitations from the second partition; and
storing newly created invitations in the new partition, the newly created invitations being created after the threshold amount of time has elapsed since the first date.

3. The method of claim 1, further comprising:
creating a new partition in the plurality of database instances after a threshold amount of time has elapsed since the first date;
deleting the existing invitations from the second partition; and
storing newly created invitations in the new partition, the newly created invitations being created after the threshold amount of time has elapsed since the first date.

4. The method of claim 1, further comprising:
establishing a connection between an invitee and an inviter in response to an acceptance of the invitation request by the invitee; and
updating the invitation information stored in either the first partition or the second partition to include the acceptance of the invitation request by the invitee.

5. The method of claim 1, further comprising:
archiving the invitation information stored in either the first partition or the second partition in response to an inviter withdrawing the invitation request.

6. The method of claim 1, further comprising:
in response to a rejection to the invitation request by an invitee, updating the invitation information stored in either the first partition or the second partition to include the rejection of the invitation request by the invitee.

7. The method of claim 1, further comprising:
in response to an ignore request by an invitee to the invitation request, updating the invitation information stored in either the first partition or the second partition to include the ignore request by the invitee.

8. The method of claim 1, wherein the invitation module has read permissions, update permissions and write permissions in the first partition.

9. The method of claim 1, wherein the invitation module has read permissions and update permissions in the second partition.

10. The method of claim 1, wherein the plurality of database instances are online, and old invitations that are archived are taken offline.

11. A system comprising:
one or more processors;
an invitation module configured to:
maintain a plurality of database instances, the plurality of database instances having a first partition and a second partition;
assign first invitations to the first partition, the first invitations being created after a first date;
assign existing invitations to the second partition, the existing invitations being created before the first date and after a second date, and wherein the second date occurred before the first date;
archive old invitations, the old invitations being created before the second date;
a network interface configured to:
receive an invitation request, the invitation request having at least one of an invitee identifier, an inviter identifier, and a unique identifier;
request invitation information associated with the invitation request from the first partition and the second partition using at least one of the invitee identifier, the inviter identifier, and the unique identifier; and
receive the requested invitation information.

12. The system of claim 11, wherein after a threshold amount of time has elapsed since the first date, the invitation module is further configured to:
create a new partition in the plurality of database instances;
archive the existing invitations from the second partition; and
store newly created invitations in the new partition, the newly created invitations being created after the threshold amount of time has elapsed since the first date.

13. The system of claim 11, wherein after a threshold amount of time has elapsed since the first date, the invitation module is further configured to:
create a new partition in the plurality of database instances;
delete the existing invitations from the second partition; and
store newly created invitations in the new partition, the newly created invitations being created after the threshold amount of time has elapsed since the first date.

14. The system of claim 1, wherein in response to an acceptance of the invitation request by an invitee, the invitation module is further configured to:
establish a connection between the invitee and an inviter; and
update the invitation information stored in either the first partition or the second partition to include the acceptance of the invitation request by the invitee.

15. The system of claim 11, wherein the invitation module is further configured to:
archive the invitation information stored in either the first partition or the second partition in response to an inviter withdrawing the invitation request.

16. The system of claim 11, wherein in response to an ignore request by an invitee to the invitation request, the invitation module is further configured to:
update the invitation information stored in either the first partition or the second partition to include the ignore request by the invitee.

17. The system of claim 11, wherein the invitation module has read permissions, update permissions and write permissions in the first partition.

18. The system of claim 11, wherein the invitation module has read permissions and update permissions in the second partition.

19. A non-transitory machine-readable storage medium comprising instructions that, when executed by one or more processors of a machine, cause the machine to perform operations comprising:
maintaining a plurality of database instances, the plurality of database instances having a first partition and a second partition;
assigning first invitations to the first partition, the first invitations being created after a first date;
assigning existing invitations to the second partition, the existing invitations being created before the first date and after a second date, and wherein the second date occurred before the first date;
archiving old invitations, the old invitations being created before the second date;
receiving an invitation request, the invitation request having at least one of an invitee identifier, an inviter identifier, and a unique identifier;
requesting invitation information associated with the invitation request from the first partition and the second partition using at least one of the invitee identifier, the inviter identifier, and the unique identifier; and
receiving the requested invitation information.

20. The non-transitory machine-readable storage medium of claim 19, further comprising instructions that cause the machine to perform operations comprising:
creating a new partition in the plurality of database instances after a threshold amount of time has elapsed since the first date;
archiving the existing invitations from the second partition; and
storing newly created invitations in the new partition, the newly created invitations being created after the threshold amount of time has elapsed since the first date.
